(19) United States
(12) Patent Application Publication
(10) Pub. No.: US 2012/0146298 A1
(43) Pub. Date: Jun. 14, 2012

(54) EASILY-POSITIONED CUTTER CHUCK

(76) Inventor: Chin-Chiu CHEN, Cingshuei Chen (TW)

(21) Appl. No.: 12/964,008

(22) Filed: Dec. 9, 2010

(51) Int. Cl. B23B 31/02

(52) U.S. Cl. 279/9.1

(57) ABSTRACT

An easily-positioned cutter chuck has a through hole formed through the cutter chuck. The through hole has an end and a reamed part formed at the end of the through hole and reaming outwardly at two gradients. Because the reamed part enlarges an area ratio of an opening of the through hole to an end surface of the cutter chuck, a protrusion of a positioning apparatus can be easily aimed at and inserted into the reamed part. Because the cutter chuck can be held and positioned steadily by the positioning apparatus, tolerances of the cutter chuck can be well controlled when the outer surface of the cutter chuck is processed for polishing.

### BACKGROUND OF THE INVENTION

1. Field of the Invention

The present invention relates to a cutter chuck, and more particularly to an easily-positioned cutter chuck having a reamed part for easy positioning.

2. Description of Related Art

With reference to FIGS. 5 to 6, a conventional cutter chuck 80 in accordance with the prior art has a through hole 81 formed axially through the cutter chuck 80 and has a cutter section 82 allowing a cutter to be inserted into for cutting a workpiece.

When an outer surface of the cutter chuck 80 is being polished, two protrusions of a positioning apparatus are respectively inserted into two ends of the through hole 81 for holding and positioning the cutter chuck 80.

However, the inner surface of each end of the through hole 11 is linear such that an area ratio of an opening of each end of the through hole 81 to an end surface of the cutter chuck 80 is relatively small. Consequently, to aim the protrusions of the positioning apparatus at the small openings of the ends of the through hole 81 for positioning the cutter chuck 80 is difficult.

Moreover, the cutter is inserted into the through hole 81 at the cutter section 82 by means of thermal expansion and contraction and the cutter can only be detached from the cutter chuck 80 after the cutter section 82 is heated. However, the heat distribution of the end of the through hole 81 located at the cutter section 82 is slow and uneven when the cutter section 82 is heated, and therefore detaching the cutter is difficult and cannot proceed smoothly.

To overcome the shortcomings, the present invention tends to provide an easily-positioned cutter chuck to mitigate the aforementioned problems.

### SUMMARY OF THE INVENTION

The main objective of the invention is to provide an easily-positioned cutter chuck having a reamed part for easy positioning.

An easily-positioned cutter chuck has a through hole formed through the cutter chuck. The through hole has an end and a reamed part formed at the end of the through hole and reaming outwardly at two gradients. Because the reamed part enlarges an area ratio of an opening of the through hole to an end surface of the cutter chuck, a protrusion of a positioning apparatus can be easily aimed at and inserted into the reamed part. Because the cutter chuck can be held and positioned steadily by the positioning apparatus, tolerances of the cutter chuck can be well controlled when the outer surface of the cutter chuck is processed for polishing.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of an easily-positioned cutter chuck in accordance with the present invention;

FIG. 2 is a side view in partial section of the easily-positioned cutter chuck in FIG. 1;

FIG. 3 is an enlarged side view of the easily-positioned cutter chuck in FIG. 2;

FIG. 4 is a schematic diagram of the easily-positioned cutter chuck in FIG. 2, showing a relationship between the first rim and the second rim; and

FIG. 5 is a perspective view of a conventional cutter chuck in accordance with the prior art; and

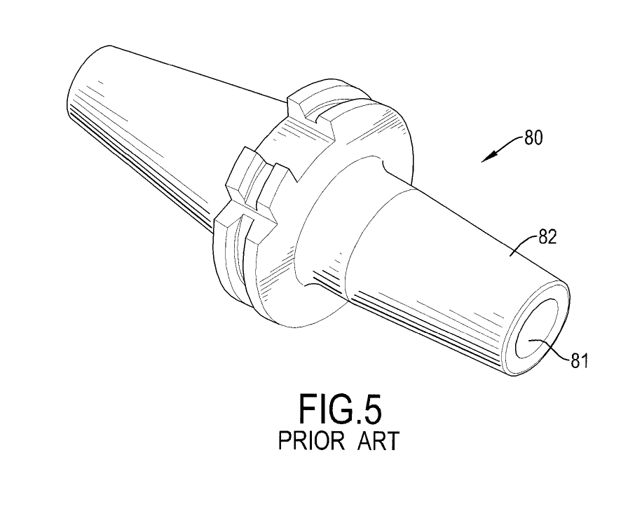

FIG. 6 is a side view in partial section of the cutter chuck in FIG. 5.

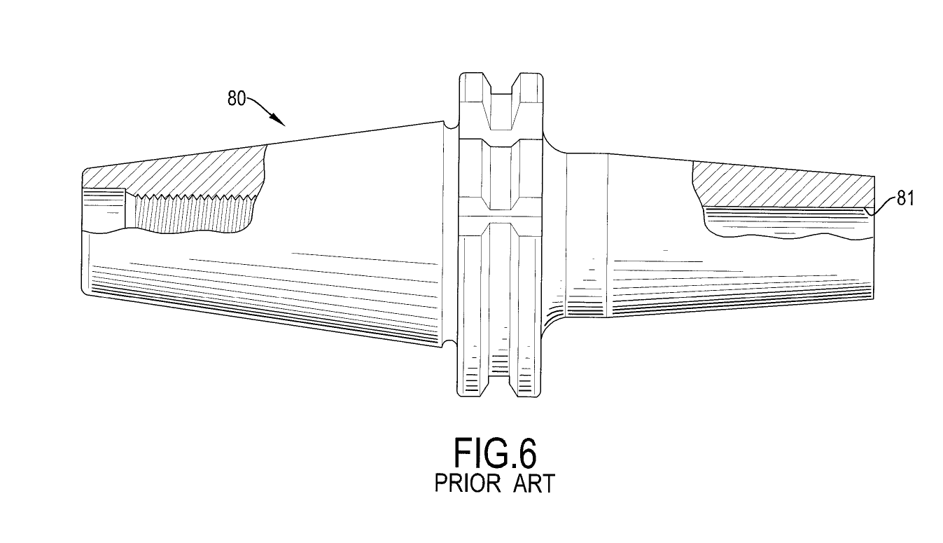

### DETAILED DESCRIPTION OF PREFERRED EMBODIMENT

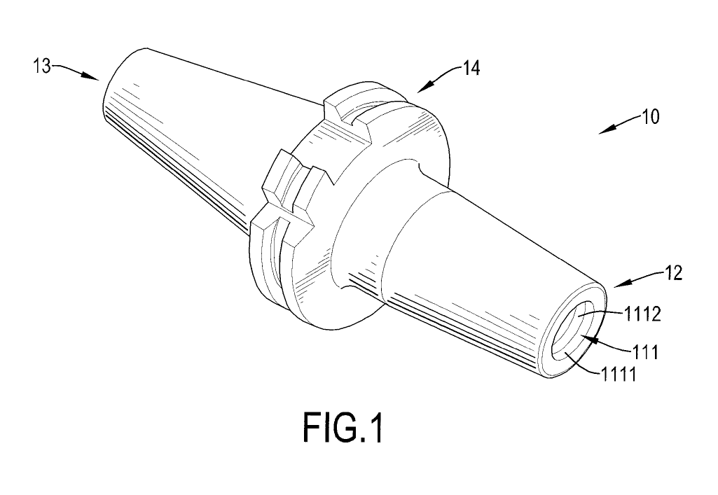

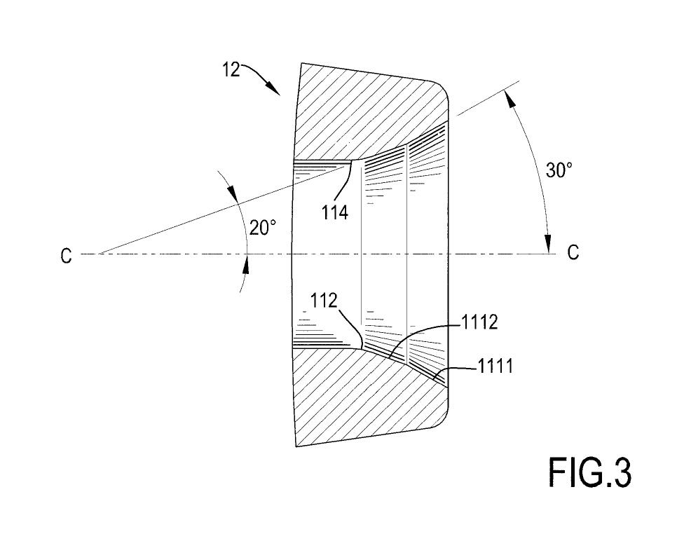

With reference to FIGS. 1 to 3, an easily-positioned cutter chuck 10 in accordance with the present invention comprises a through hole 11, a cutter section 12, an axle section 13 and a flange 14.

The axle section 13 is opposite to the cutter section 12 and is capable of being securely positioned on an axle of a tooling machine. The flange 14 is located between the cutter section 12 and the axle section 13. The cutter chuck 10, with the exception of the shape of the through hole 11, may be conventional in structure and detailed description of the cutter section 12, the axle section 13 and the flange 14 is omitted.

The through hole 11 is axially formed through the cutter chuck 10 and has an end, an inner surface, a central segment, a reamed part 111, a convex border 112, a groove 113, a first rim 114 and a second rim 115. The end of the through hole 11 is located in the cutter section 12.

The reamed part 111 is formed at the end of the through hole 11, reams outwardly at two gradients and has a first segment 1111 and a second segment 1112. The first segment 1111 of the reamed part 111 is annular. The second segment 1112 of the reamed part 111 is annular, is located between the first segment 1111 and the central segment of the through hole 11 and is adjacent to the first segment 1111 of the reamed part 111.

The convex border 112 is annular, is located between and adjacent to the central segment of the through hole 11 and the second segment 1112 of the reamed part 111.

The groove 113 is annular, is formed around the inner surface at the central segment of the through hole 11 and is located at the cutter section 12.

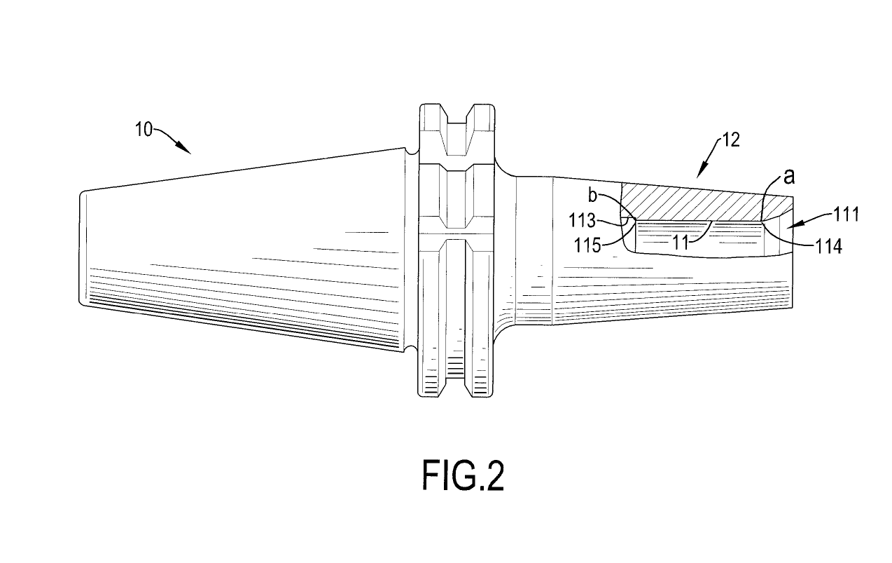

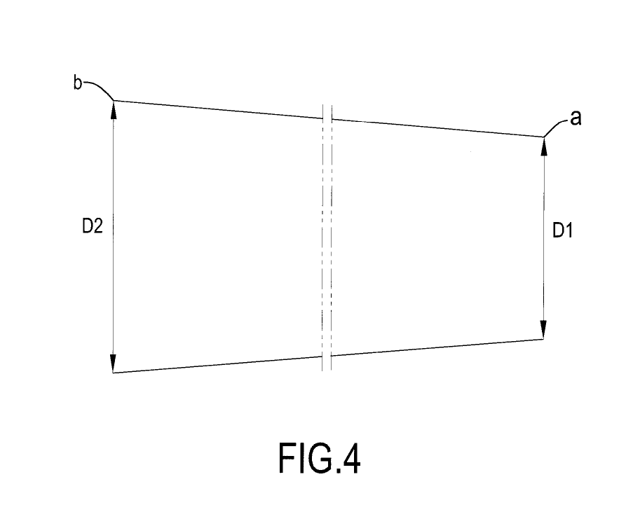

With reference to FIGS. 2 to 4, the first rim 114 is formed around the inner surface at the central segment of the through hole 11, is adjacent to the convex border 112 and having a diameter D1. FIG. 4 is a schematic diagram of FIG. 2 to show a relationship between the first rim 114 and the second rim 115.

The second rim 115 is formed around the inner surface at the central segment of the through hole 11, is located between the groove 113 and the first rim 114, is adjacent to the groove 113 and has a diameter D2 larger than the diameter D1 of the first rim 114. A point a is located at the first rim 114 and a point b is located at the second rim 115. However, an inclination of the line ab in FIG. 4 is schematic for easy comprehension and does not represent the actual inclination of the line ab. A difference in diameters D1,D2 between the first rim 114 and the second rim 115 ranges from 0.5 μm (micrometer) to 4 μm (micrometer).

Preferably, the through hole 11 has an axis C (the dotted line). The first segment 1111 of the reamed part 111 has an inner surface. The second segment 1112 of the reamed part 111 has an inner surface. An angle between the axis C of the through hole 11 and the inner surface of the first segment 1111 of the reamed part 111 is 30° (degree). An angle between the axis C of the through hole 11 and the inner surface of the second segment 1112 of the reamed part 111 ranges from 10° to 20°.

From the above description, it is noted that the present invention has the following advantages:

1. Easy Positioning:

Because the reamed part 111 enlarges an area ratio of an opening of the through hole 11 to an end surface of the cutter chuck 10, a protrusion of a positioning apparatus can be easily aimed at and inserted in the reamed part 111. Because the cutter chuck 10 can be held and positioned steadily by the positioning apparatus, tolerances of the cutter chuck 10 can be well controlled when the outer surface of the cutter chuck 10 is processed for polishing.

2. Easy Detachment of a Cutter:

Because the reamed part 111 enlarges the opening of the through hole 11, a cutter is easily detached from the cutter chuck 10. Moreover, By means of the convex border 112 and that the diameter D2 of the second rim 115 is larger than the diameter D1 of the first rim 114, easy detaching of the cutter from the through hole 11 is further facilitated.

3. Enhanced Heat-Dissipating Effect:

The reamed part 111 increases the inner area of the through hole 11 to enhance the heat-dissipating effect when the cutter chuck 10 connected with the cutter is cutting a workpiece.

4. Easy Efflux of Cooling Liquid:

The cooling liquid in the through hole 11 easily flows out from the reamed part 111 because the reamed part 111 enlarges the opening of the through hole 11.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An easily-positioned cutter chuck for holding a cutter thereon, the easily-positioned cutter chuck comprising:
a cutter section;
an axle section opposite to the cutter section;
a flange located between the cutter section and the axle section and capable of being securely positioned on an axle of a tooling machine; and
a through hole axially formed through the cutter chuck and having
an end located in the cutter section;
an inner surface;
a central segment;
a reamed part formed at the end of the through hole, reaming outwardly at two gradients and having
an annular first segment; and
an annular second segment located between the first segment and the central segment of the through hole and adjacent to the first segment of the reamed part;
an annular convex border located between and adjacent to the central segment of the through hole and the second segment of the reamed part;
an annular groove formed around the inner surface at the central segment of the through hole and located at the cutter section;
a first rim formed around the inner surface at the central segment of the through hole, adjacent to the convex border and having a diameter; and
a second rim formed around the inner surface at the central segment of the through hole, located between the groove and the first rim, adjacent to the groove and having a diameter larger than that of the first rim, wherein a difference in diameters between the first rim and the second rim ranges from 0.5 μm (micrometer) to 4 μm (micrometer).

2. The easily-positioned cutter chuck as claimed in claim 1, wherein
the through hole has an axis;
the first segment of the reamed part has an inner surface;
the second segment of the reamed part has an inner surface;
an angle between the axis of the through hole and the inner surface of the first segment of the reamed part is 30° (degree); and
an angle between the axis of the through hole and the inner surface of the second segment of the reamed part ranges from 10° to 20°.
